(19) United States
(12) Patent Application Publication
(10) Pub. No.: US 2013/0061741 A1
(43) Pub. Date: Mar. 14, 2013

(54) DUAL MODE FLUID POWERED ACTUATOR

(71) Applicants: Carsten Link, Burlington (CA); Robert Belair, Erin (CA)

(72) Inventors: Carsten Link, Burlington (CA); Robert Belair, Erin (CA)

(21) Appl. No.: 13/611,904

(22) Filed: Sep. 12, 2012

Related U.S. Application Data
(60) Provisional application No. 61/533,490, filed on Sep. 12, 2011.

(51) Int. Cl. F15B 15/14

(52) U.S. Cl. 91/422

(57) ABSTRACT

A dual-mode fluid powered actuator includes a cylinder housing having a cylinder axis, a first end and a second end spaced axially apart from the first end, and an inner surface extending between the first and second ends. A first fluid port is provided adjacent the first end of the cylinder housing and a second fluid port is provided adjacent the second end of the cylinder housing. A piston assembly is in the cylinder housing, the piston assembly slidable between the first and second ports. The piston assembly includes a first piston member and a second piston member, the first and second piston members translatable relative to each other between an engaged position in which the piston assembly isolates the first fluid port from the second fluid port, and a disengaged position in which the first and second fluid ports are in fluid communication with each other through the piston assembly.

This application claims the benefit of Provisional Application Ser. No. 61/533,490, filed Sep. 12, 2011, which is hereby incorporated herein by reference.

### FIELD

The teaching disclosed herein generally relates to fluid powered actuators that can be used to apply positioning forces, press forces or clamping forces, and/or to piston/cylinder assemblies in which the piston can selectively be moved within the cylinder by an external force, and to methods of using related apparatuses or devices.

### BACKGROUND

U.S. Pat. No. 5,237,916 (Malashenko) discloses a regenerative hydraulic cylinder having a piston dividing its interior into a pair of chambers. A rod extends from the piston through a cylinder end wall. Several axial passages in the piston extend between opposite piston faces. A valve member is mounted over one piston face and has a sleeve that slides axially in a recess formed in the one piston face. Springs urge the valve member to a flow-impeding orientation against the piston face. A hydraulic pilot line in the rod, accessible at an external rod end, permits the valve member to be displaced away from the piston face to a flow-enabling orientation. The valve state is controlled to permit fluid flow directly between chambers during extension or contraction of the cylinder.

U.S. Pat. No. 7,413,063 (Davis) discloses a strut configured for an active suspension system which provides electronic control for both the force applied by the strut and the dampening characteristics of the strut. A compressible fluid is used within the strut, and preferably includes a compressible base fluid and electromagnetic field responsive particles which are suspended in the compressible base fluid. The electromagnetic field responsive particles are preferably closely matched in density and modulas of elasticity to that of the compressible base fluid to prevent sedimentation of the particles and to maintain the elasticity of the compressible fluid. The amount compressible fluid within the strut is electronically controlled to determine the force applied by the strut and a field strength applied to the compressible fluid in a fluid flow passage is electronically controlled to determine the dampening characteristics of the strut.

U.S. Pat. No. 7,611,346 (Schad) discloses a clamp actuator of a molding system. The clamp actuator includes a first actuator configured to be interactable with a rod; and a second actuator configured to be interactable with the first actuator. The first actuator is configured to apply a clamping force to the rod; and the second actuator is configured to apply a force opposing the clamping force to the first actuator. Responsive to actuating the first actuator, the rod is drivable between (i) a home position in which a clamping force is not applicable to the rod, and (ii) a force application position in which the clamping force is applicable to the rod. Responsive to a mold flash occurring which exceeds the clamping force, the rod is moveable into a mold flash position beyond the home position.

U.S. Pat. No. 7,740,256 (Davis) discloses an active, independent suspension system having dual piston, compressible fluid struts. Each of the dual piston struts has an outer cylinder and an outer piston rod, which each respectively define exterior peripheries for an outer pressure chamber and an inner pressure chamber. Pressures applied to a compressible fluid in respective ones of the outer and inner pressure chambers urge the outer piston to extend from within the outer cylinder. A control system is provided for actively controlling an amount of compressible fluid disposed within each of the outer and inner chambers.

U.S. Pub. Appln. No. 2008/0202115 (Geiger) discloses a mechanical-hydraulic machine and an integrated hybrid drive with a regenerative force assist for eliminating pumps and intensifiers and reducing the energy consumption, operating costs, investment costs, weight and size of machines and improving their performance. The integrated hybrid drive is comprised of common mechanical and hydraulic components. The regenerative hydraulic force assist converts gravitational and deceleration forces of the machine into fluid pressure, stores the fluid pressure and applies the fluid pressure to clamping of dies or molds and/or performing machine operations. A closed loop control system controls the flow of fluid between the hydraulic drive and regenerative force assist.

### SUMMARY

The following summary is intended to introduce the reader to this specification but not to define any invention. In general, this specification discusses one or more methods or apparatuses related to fluid powered actuators, cylinder/piston assemblies, and/or clamping mechanisms, and to methods of applying positioning and/or clamp forces in, for example, presses, injection molding machines, electro-hydraulic linear actuators, drill rigs, tunnel boring machines, earth movers, construction and mining machinery, or other equipment.

According to some aspects, a fluid powered actuator, comprises: a) a cylinder housing having a cylinder axis, a first end and a second end spaced axially apart from the first end, and an inner surface extending between the first and second ends; b) a first fluid port adjacent the first end of the cylinder housing and a second fluid port adjacent the second end of the cylinder housing; c) a piston assembly in the cylinder housing, the piston assembly slidable between the first and second ports; and d) the piston assembly including a first piston member and a second piston member, the first and second piston members translatable relative to each other between an engaged position in which the piston assembly isolates the first fluid port from the second fluid port, and a disengaged position in which the first and second fluid ports are in fluid communication with each other through the piston assembly.

In some examples, at least one of the first and second piston members has an outer piston seal in sealed sliding engagement with the inner surface of the cylinder housing. The actuator may include a first fluid chamber adjacent the first end of the cylinder housing and a second fluid chamber adjacent the second end of the housing, the first and second fluid chambers in sealed isolation from each other by the first and second piston members when in the engaged position. In some examples, the first piston member may have a first seal surface and the second member may have a second seal surface, and the first and second seal surfaces may abut when the first and second piston members are in the engaged position, and the first and second seal surfaces may be spaced apart when the first and second piston members are in the disengaged position.

In some examples, the first seal surface is affixed to the first piston member and is generally immovable relative to the first piston member during use of the actuator, and the second seal surface is affixed to the second piston member and is generally immovable relative to the second piston member during use of the actuator. The first seal surface may be directed at least partially towards the first end. The second seal surface may be directed at least partially towards the second end.

According to some aspects, a dual-mode fluid powered actuator includes: a) a cylinder housing having a cylinder axis, a first end and a second end spaced axially apart from the first end, and an inner surface extending between the first and second ends; b) a piston assembly in the cylinder housing, the piston assembly slidable between the first and second ends, the piston assembly generally defining a first fluid chamber adjacent the first end and a second fluid chamber adjacent the second end; and c) the piston assembly including a first piston member and a second piston member, each of the first and second piston members independently translatable relative to the cylinder housing in a direction parallel to the cylinder axis, and the first and second piston members translatable relative to each other for selectively engaging with each other and disengaging from each other; d) wherein when the first and second piston members are engaged with each other, the first and second piston members abut and fluid flow between the first and second fluid chambers inside the cylinder housing is inhibited, and when the first and second piston members are disengaged, the first and second piston members are spaced apart and a fluid flow path inside the cylinder housing between the first and second chambers is opened.

According to some aspects, a method of positioning and/or and pressing a load includes: a) moving a first seal surface of a first piston member into engagement with a second seal surface of a second piston member by translating at least one of the first and second piston members relatively towards the other of the first and second piston members within a cylinder housing, at least one of the first and second piston members connectable to a load, wherein first and second fluid chambers are isolated from each other on axially opposite sides of the first and second piston members when the first and second seal surfaces are engaged; b) pressurizing one of the first and second fluid chambers with pressurized fluid, wherein a force is exerted on the load; and c) opening a first fluid passageway across the first piston member and a second fluid passageway across the second piston member by axially separating the first and second piston members to disengage the first and second seal surfaces; d) translating at least one of the first and second piston members relative to the cylinder housing and away from the other of the first and second piston members, wherein fluid in the cylinder housing flows relative to the respective piston member across the respective piston member during translation thereof, via the respective first and second fluid passageway of the respective at least one first and second piston member.

According to some aspects, a fluid powered actuator, includes: a) a cylinder housing having a cylinder axis, a first end and a second end spaced axially apart from the first end, and an inner surface extending between the first and second ends; b) a first fluid port adjacent the first end of the cylinder housing and a second fluid port adjacent the second end of the cylinder housing; c) a piston assembly in the cylinder housing, the piston assembly slidable between the first and second ports; d) the piston assembly including a first piston member and a second piston member, the first piston member comprising a first seal surface and the second piston member comprising a second seal surface; e) the first and second piston members translatable relative to each other to selectively engage the first seal surface with the second seal surface and to disengage the first seal surface from the second seal surface; f) wherein when the first and second seal surfaces are engaged, a fluid chamber is provided in the cylinder housing on one axial side of the engaged first and second piston members for containing pressurized fluid to urge the engaged first and second piston members in one axial direction; g) wherein when the first and second seal surfaces are disengaged, fluid in the cylinder housing flows across at least one of the piston members along the respective seal surface thereof in response to axial translation of at least one of the piston members.

According to some aspects, a press assembly comprises: a) stationary die plate and a moving die plate; b) a fluid powered actuator having a first piston member coupled to the moving die plate via a first force transmission member and translatable into and out of sealed engagement with a second piston member; and d) a first external actuator coupled to the moving die plate.

According to some aspects, an injection molding machine comprises: a) a stationary platen and a moving platen; b) at least one tie bar; and c) at least one dual-mode actuator having a first piston member separately translatable into and out of sealed engagement with a second piston member, the first piston member coupled to the tie bar.

Other aspects and features of the present specification will become apparent, to those ordinarily skilled in the art, upon review of the following description of the specific examples of the specification.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a side sectional view of an actuator in accordance with aspects of the teaching described herein;

FIG. 2 is a side sectional view of the actuator of FIG. 1, showing a first piston member moved to a different position;

FIG. 3 is an enlarged view of a portion of the actuator of FIG. 1;

FIG. 4 is a schematic view of a press apparatus in accordance with aspects of the teaching described herein;

FIGS. 5, 6, and 7 are view of the press apparatus of FIG. 4, in a state ready to advance a die plate, a state with the die plate fully advanced, and a state with the die plate partially retracted, respectively;

FIG. 8a is a schematic elevation view of an injection molding machine in accordance with aspects of the teaching disclosed herein, showing the moving platen in a shutter position;

FIGS. 8b and 8c are similar schematic elevation views of the injection molding machine of FIG. 8a, showing the moving platen in a mold closed position and a mold clamped position, respectively;

FIGS. 9a-9c are sectional views of a dual-mode actuator of the injection molding machine, shown in position corresponding to the shutter position, mold closed position, and mold clamped position of FIGS. 8a, 8b, and 9c, respectively;

FIG. 9d is a sectional view of the actuator of FIGS. 9a-9c, shown in a clamp pressure relief position; and

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses or processes described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

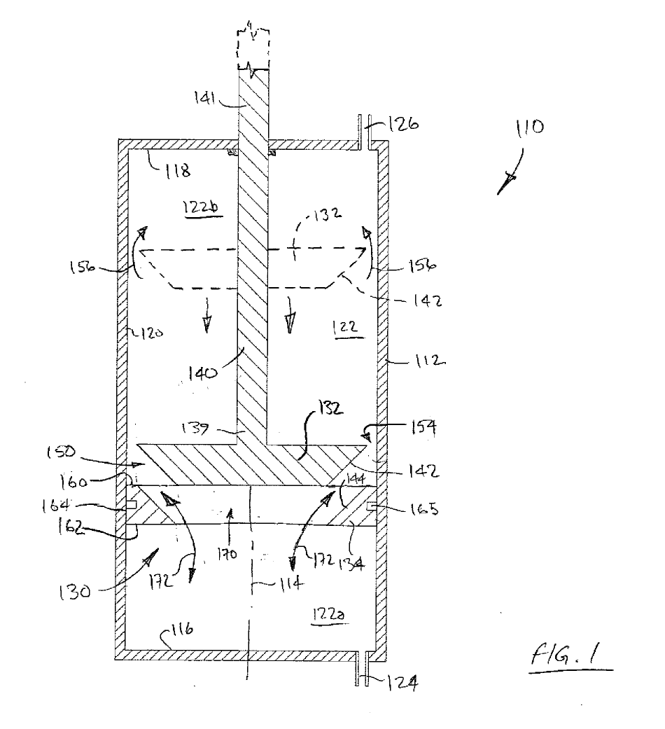

Referring to FIG. 1, a dual-mode fluid powered actuator 110 includes a cylinder housing 112 having a cylinder axis 114, with a first end 116 and a second end 118 spaced axially apart from the first end 116. An inner surface 120 extends between the first and second ends 116, 118. In the example illustrated, the inner surface 120 is generally cylindrical in shape.

The cylinder housing 112 generally encloses an interior space 122 that may be bounded at least partially by the inner cylindrical surface 120 and the first and second ends 116, 118. One or more fluid ports may be provided for fluid communication between an exterior of the cylinder housing and at least a portion of the interior space 122. In the example illustrated, the actuator 110 has a first fluid port 124 adjacent the first end 116 of the cylinder housing and a second fluid port 126 adjacent the second end 118 of the cylinder housing.

The dual-mode actuator 110 further includes a piston assembly 130 in the cylinder housing 112. The piston assembly 130 may be translatable along the cylinder axis 114. The piston assembly 130 may be translatable between the first and second ports 124, 126. The first and second fluid ports 124, 126 generally provide, in the example illustrated, fluid communication between an exterior of the cylinder housing 112 and the interior space 122 of the cylinder housing on respective axially opposite sides of the piston assembly 130.

For example, the interior space 122 of the cylinder housing includes, in the example illustrated, a first fluid chamber 122a adjacent the first end 116 of the cylinder housing 112. The first fluid port 124 provides fluid communication between an exterior of the cylinder housing 112 and the first fluid chamber 122a. The interior space 122 further includes, in the example illustrated, a second fluid chamber 122b adjacent the second end 118 of the cylinder housing 112, with the second fluid port 126 providing fluid communication between an exterior of the cylinder housing and the second fluid chamber 122b. The piston assembly 130 is disposed axially intermediate the first and second chambers 122a, 122b. At least one of the first and second ports 124, 126 may be in fluid communication with a pressurized fluid source for selectively pressurizing at least a respective one of the first and second fluid chambers 122a, 122b.

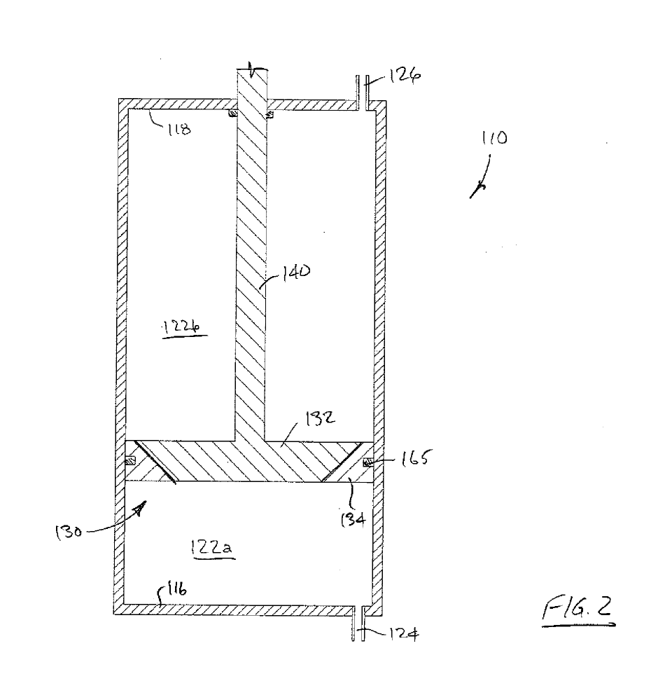

The piston assembly 130 may include a first piston member 132 and a second piston member 134. The first and second piston members 132, 134 are, in the example illustrated, translatable relative to each other between an engaged position (FIG. 2) and a disengaged position (FIG. 1).

When the first and second piston members are in the engaged position (FIG. 2), the piston assembly 130 isolates the first fluid port 124 from the second fluid port 126. The first and second chambers 122a, 122b are similarly isolated from each other within the cylinder housing 112 by the engaged first and second piston members 132, 134, and can be pressurized at different fluid pressure levels by, for example, controlling the flow of fluid into and out of the respective first and second fluid ports 124, 126.

When the first and second piston members are in the disengaged position (FIG. 1), the first and second fluid ports 124, 126 are in fluid communication with each other through the piston assembly 130. The first and second chambers 122a, 122b are similarly in fluid communication with each other through the piston assembly 130. In the example illustrated, when the first and second piston members 132, 134 are in the disengaged position, pressurized fluid introduced into either one of the first or second fluid ports 124, 126 will generally pressurize the first and second fluid chambers 122a, 122b equally.

The respective sizes of the first and second fluid chambers 122a, 122b can alternately expand as a result of translation of the first and second piston members 132, 134 away from the respective first and second ends 116, 118 of the cylinder housing 112, and can contract as a result of translation of the first and second piston members 132, 134 towards the respective first and second ends 116, 118. Relative translation of the first and second piston members apart from each other can contract the size of one or both of the first and second fluid chambers 122a, 122b, and can form an intermediate fluid chamber axially between the first and second fluid chambers 122a, 122b.

Selectively providing fluid communication or fluid isolation between the first and second fluid ports 124, 126 through the piston 130 can facilitate selectively translating one or both of the piston members 132, 134 in a “working stroke” mode or in a “positioning stroke” mode. In the working stroke mode (first and second piston members engaged), fluid may be supplied to a port to increase the fluid pressure in either one of the first or second fluid chambers 122a, 122b, thereby forcefully urging translation of the engaged piston members 132, 134 towards the other (non-pressurized, or lower-pressure) fluid chamber. A corresponding volume of fluid (i.e. a volume generally equal to the product of the distance of the axial translation of the engaged piston members and the effective surface area thereof) must be introduced into the respective port 124, 126 on the high pressure side of the piston assembly, and the same volume of fluid (assuming for simplicity that the fluid is generally non-compressible) must be evacuated through the other port 126, 124 on the opposite, low pressure side of the piston assembly 130.

In the “positioning stroke” mode (first and second piston members disengaged), fluid communication is provided across each piston member 132, 134 (i.e. from one axial side to the other) so that fluid communication is provided between the first and second fluid ports 124, 126, through the piston assembly 130. As a result, either one of the piston members 132, 134 may be translated independently of the other piston member (e.g. by an external force), with some fluid already inside the interior space 122 passing across that respective translating piston member (the fluid that passes across the translating piston is referred to herein as “bypass fluid”).

The bypass fluid can reduce the amount of fluid that would otherwise need to be introduced (under pressure) to the fluid port on the high pressure side of the piston member, and the amount of fluid that would otherwise need to be evacuated from the low pressure side of the piston member, if fluid flow through the piston was not provided during the positioning stroke.

The external force (to translate one of the piston members 132, 134 when in the disengaged position) may be exerted by an external actuator that is isolated from the first and second fluid chambers and is coupled to the translating piston member 132, 134. The external actuator may be, for example, a pneumatic, hydraulic, or electric actuator that generates a force regardless of pressurization of the first or second fluid chambers 122a, 122b. The external actuator may be configured for translation at relatively high speed and relatively low force. For example, the external actuator may comprise an electrically driven ball screw coupled to the first force transmission member (i.e. the piston rod 140) and may urge the piston rod (and first piston member 132 fixed thereto) inward, towards the first end 116 of the cylinder housing 112.

The piston assembly 130 may comprise at least one force transmission member for connecting the external actuator to the piston member 132, 134 to be translated thereby. In the example illustrated, the piston assembly 130 includes a first force transmission member in the form of a piston rod 140 having an inner rod end 139 fixed to the first piston member 132, and an outer rod end 141 extending external of the cylinder housing 112. In the example illustrated, the outer rod end 141 passes through an aperture in the second end 118 of the cylinder housing 112. The outer rod end 141 may be engaged by or coupled to the external actuator.

In some examples, the piston assembly may include a second force transmission member fixed to the second piston member and engageable by a second external actuator, the second external actuator isolated from the first and second fluid chambers 132, 134 (i.e. isolated from the interior of the cylinder housing that is in communication with at least one of first and second ports 124, 126).

In some examples, the piston assembly may include a force transmission member in the form of a shoulder surface or pressure surface fixed to one of the first or second piston members 132, 134, and engaged by an external actuator in the form of a third fluid chamber isolated from the first and second chambers. Such a shoulder surface may extend radially inwardly of the inner surface 120 of the cylinder housing 112, and may enclose a portion of the third fluid chamber.

In some examples, the piston assembly may include a force transmission member in the form of a magnet or other material fixed to one of the first or second piston members 132, 134, and responsive to a magnetic field that can be generated, for example, by energizing an external actuator in the form of a current-carrying coil.

In the example illustrated, to facilitate dual-mode operability of the fluid powered actuator, the first piston member 132 has a first seal surface 142 and the second piston member 134 has a second seal surface 144. The first and second seal surfaces 142, 144 abut when the first and second piston members 132, 134 are in the engaged position, and the first and second seal surfaces are spaced apart when the first and second piston members are in the disengaged position.

Furthermore, at least one of the first and second piston members may have an outer piston seal 165 in sealed sliding engagement with the inner surface of the cylinder housing. In the example illustrated, the second piston member 134 has an outer radial surface, and the piston seal 165 is retained in a groove in the outer radial surface 164.

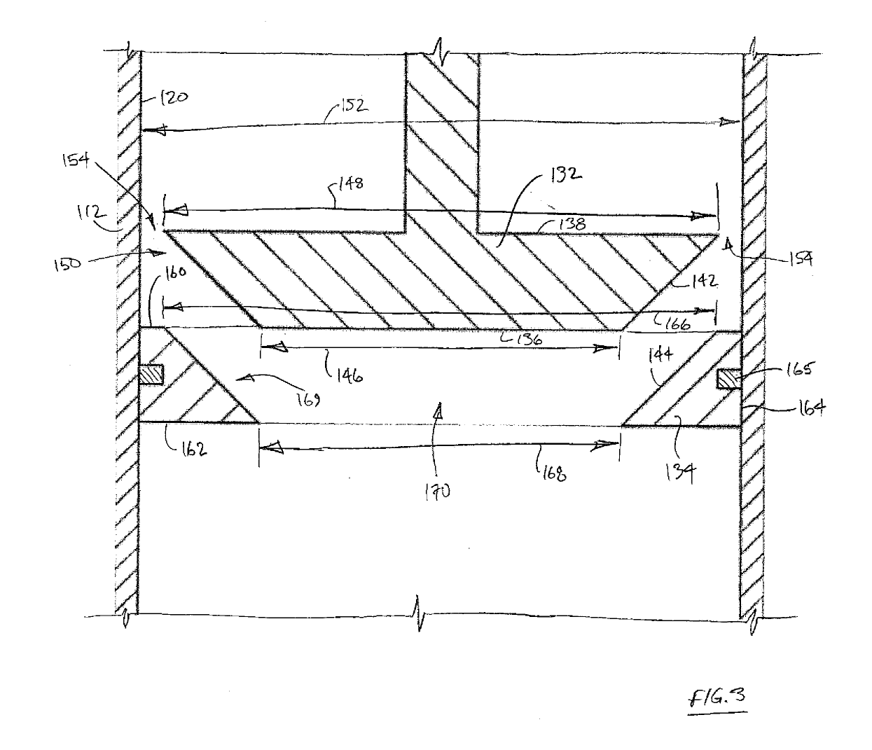

With reference also to FIG. 3, the first seal surface 142 may be fixed to the first piston member 132 and may be generally immovable relative to the first piston member 132 during use of the actuator 110. In the example illustrated, the first piston member 132 has a first body that is generally frusto-conical in shape. The first body has a first member front face 136 and a first member back face 138 spaced axially apart from the first member front face 136. In the example illustrated, the first member back face 138 is generally circular and has a back face outer diameter 148 that is greater than the front face outer diameter 146 of the first member front face. The first body has a first outer radial surface 150 that extends between the first member front and back faces 136, 138. The first outer radial surface 150 tapers radially inwardly along the axial direction from the back face 138 to the front face 136.

In the example illustrated, the first seal surface 142 comprises at least a portion of the first outer radial surface 150 of the first piston member 132. Thus, in the example illustrated, the first seal surface 142 generally comprises a first tapered surface disposed along a radially outer portion of the first piston member 132. In the example illustrated, the first seal surface 142 extends around the circumference of the first piston member 132, and is coaxial with the cylinder axis 114. The first seal surface 142 may be tapered at an oblique angle relative to the cylinder axis, and in the example illustrated is tapered at an angle of about 45 degrees. In some examples, the first seal surface may comprise a plurality of discrete, spaced-apart first seal surface portions.

In the example illustrated, the first seal surface 142 is directed at least partially towards the first end 116 of the cylinder housing 112. As a result, the first seal surface 142 has a first projected area in a plane perpendicular to the cylinder axis 114 and disposed axially between the first seal surface 142 and the first end 116.

Referring again to FIG. 3, the first piston member 132 has an outer diameter 148 that is, in the example illustrated, generally defined by the outer diameter of the back face 138. The outer diameter of the first piston member 132 is less than the inner diameter 152 of the inner surface 120 of the cylinder housing 112 within which the first piston 132 member translates, so that an annular gap 154 is provided between the outer diameter of the first piston member and the inner surface of the cylinder housing. A first fluid passageway 156 (FIG. 1) is, in the example illustrated, generally formed along and between the first seal surface 142 and the inner surface 120 of the cylinder housing, through the annular gap 154. Fluid in the cylinder housing 112 can pass through the first fluid passageway 156 when the first piston member 132 translates toward and away from the second piston member 134.

The second seal surface 144 may be fixed to the second piston member 134 and is, in the example illustrated, generally immovable relative to the second piston member 134 during use of the actuator 110. In the example illustrated, the second piston member 134 has a generally ring-shaped body, with an annular second member front face 160 and an annular second member back face 162, each generally perpendicular to the cylinder axis 114 and having an outer diameter slightly less than the inner diameter 152 of the inner surface 120 of the cylinder housing 112.

The second piston member 134 further includes, in the example illustrated, an outer radial surface 164 (generally parallel to the inner surface 120 of the cylinder housing 112) and extending between the outer diameters of the front and back faces 160, 162. A piston seal 165 may be mounted in the outer radial surface 164, the piston seal 165 providing sealed engagement with the inner surface 120 of the cylinder housing.

In the example illustrated, the annular second member front face 160 has an inner diameter 166 and the annular second member back face 162 has an inner diameter 168 that is less than the inner diameter 166 of the second member front face 162. A second radially inner surface 169 extends between the inner peripheries of the first and second annular faces 160, 162. At least a portion of the second radially inner surface can be tapered. In the example illustrated, the inner radial surface 169 is generally a continuous tapered surface, tapering inwardly along an axial direction from the second member front face 160 to the back face 162.

The second seal surface 144 comprises at least a portion of the second radially inner surface 169. In other words, in the example illustrated, the second seal surface 144 comprises at least a portion of a second tapered surface disposed along a radially inner portion of the second piston member 134, connecting together the front and back faces 160, 162 of the second piston member 134. The second seal surface 144 is directed at least partially towards the second end 118. As a result, the second seal surface 144 has a second projected area in a second plane perpendicular to the cylinder axis 114 and disposed axially between the second seal surface and the second end 118. The second seal surface 144 extends about an inner circumference of the second piston member, and is coaxial with the cylinder axis.

The second piston member 134 has a generally open central bore 170 bounded radially by the inner radial surface (i.e. the tapered seal surface 144, in the example illustrated). A second fluid passageway 172 is provided, in the example illustrated, generally along the second seal surface 144 and through the bore 170. Fluid in the cylinder housing can pass through the second fluid passageway 172 when the second piston member 134 translates toward and away from the first piston member 132.

The first and second seal surfaces 142, 144 are, in the example illustrated, moveable in the axial direction (with the respective first and second piston members to which they are fixed), and are generally inhibited from lateral movement (perpendicular to the cylinder axis). In the lateral (or radial) direction, at least portions of the first and second seal surfaces are in alignment with each other.

In the example illustrated, when the first and second piston members 132, 134 are in the disengaged position, at least a portion of the second seal surface 144 is disposed axially between at least a portion of the first seal surface 142 and the first end 116.

When the first and second piston members 132, 134 are in the engaged position, axial translation of the first piston member 132 towards the first end 116 causes a corresponding axial translation of the second piston member 134 towards the first end 116. Furthermore, when the first and second piston members 132, 134 are in the engaged position, axial translation of the second piston member 134 towards the second end 118 causes a corresponding axial translation of the first piston member 132 towards the second end 118. The engaged seal surfaces 142, 144 may transfer axial forces between the first and second piston members 132,134.

When the first piston member 132 is spaced apart from the second end 118, the first piston member 132 is translatable away from the first end 116 without translating the second piston member 134. Similarly, when the second piston member 134 is spaced apart from the first end 116, the second piston member 134 is translatable away from the second end 118 without translating the first piston member 132.

In use, the first piston member may be at a retracted position adjacent the second end 118 of the cylinder housing (shown in phantom in FIG. 1), and the second piston member 134 may be at home position spaced axially intermediate the first piston member 132 and the first end 116 of the cylinder housing 112. The first and second seal surfaces 142 and 144 are spaced apart from each other, corresponding to a disengaged position.

The dual-mode actuator 110 may be operated in the positioning stroke mode by axially advancing the first piston member towards the second piston member by an external actuator. The external actuator may be configured for translation at relatively high speed and relatively low force. For example, the external actuator may comprise an electrically driven ball screw or other actuator coupled to the first force transmission member (i.e. the piston rod 140) and may urge the piston rod (and first piston member 132 fixed thereto) inward, towards the first end 116 of the cylinder housing 112.

During translation of the first piston member towards the second piston member, fluid in the cylinder on the front face side (first chamber side) of the first piston member can flow across the first piston member through the first fluid passageway to the back face side (second chamber side) of the first piston member. The fluid from the first chamber side that flows across the first piston member (the bypass fluid) need not be evacuated from the cylinder housing, for example via the first fluid port 124. This can reduce resistance to advancement of the first piston member (for example, resistance associated with pushing a relatively large volume of fluid through a relatively small orifice), and can also reduce the amount of fluid required from a pressurized fluid source to back fill the second chamber side of the first piston member 132.

In the example illustrated, insertion of the piston rod into the cylinder housing causes a decrease in the volume of the space 122 within the cylinder housing, so that some fluid (“evacuation fluid”) will generally be evacuated through either one of the ports 124, 126. However, the volume of the evacuation fluid is less than would be the case if no fluid could bypass the first piston member 132 as described above. In some examples, the first piston member can be configured with a double rod-end piston, so that a second piston rod extends from the first piston member and out through the first end 116 of the cylinder housing. The second rod end may be sized to have the same or similar diameter as the first rod end, so that the change in interior volume of the space 122 inside the cylinder housing as a result of translation of the first piston member can be reduced or eliminated.

Referring to FIG. 2, once the first piston member 132 has been advanced by the external actuator to bring the first seal surface 142 into engagement with the second seal surface 144, the dual-mode actuator may be operated in the working stroke mode by pressurizing the second chamber 122b with fluid via the second fluid port 126. The pressure in the second chamber 122b urges the sealed first and second piston members 132, 134 towards the first end, which can transmit a corresponding positioning, pressing, or clamping force on a load coupled to the piston rod 140. Fluid in the first chamber 122a can be evacuated via the first fluid port 124 in response to the advancing piston members 132, 134.

Afterwards, the first chamber 122a may be pressurized to urge the first and second piston members 132, 134 away from the first end 116. This retraction translation can facilitate moving the second piston member 134 back to its home position (as shown in FIG. 1). Back pressure in the second chamber 122b and/or a resistive load applied to first piston member 132 (via, for example, piston rod 140) can help to hold the first piston member 132 in sealed engagement with the second piston member 134 when the first chamber 122a is pressurized for retracting the second piston member 134.

Referring to FIG. 4, a press actuator 200 incorporating another example of a dual-mode fluid powered actuator 210 is schematically illustrated. The press apparatus 200 includes a stationary die plate 202 and a moving die plate 204 that can be pressed together to shape a workpiece 203 positioned between the die plates 202, 204.

The fluid powered actuator 210 is substantially the same as the fluid powered actuator 110 described previously, and similar features are identified by like reference characters, incremented by 100. One difference is that in the example illustrated, the first force transmission member 240 of the actuator 210 comprises a double-ended piston rod, having a first rod segment 240a with a first inner end 239a connected to the front face 236 of the first piston member 232, and a second rod segment 240b with a second inner end 239b connected to the back face 238 of the first piston member.

In the example illustrated, the first rod segment 240a has a first outer end 241a protruding through the first end 216 of the cylinder housing 212 and connected to the moving die plate 204. The second rod segment 240b has a second outer end 241b protruding through the second end 218 of the cylinder housing 212, and connected to an external actuator 206. The first and second rod segments 240a, 240b of the double-ended piston rod have, in the example illustrated, generally equal diameters. The first rod segment 240a passes through the central bore 270 of the second piston member 234. The second fluid passageway 272 across the second piston member 234, in the example illustrated, passes through an annular gap provided between the outer surface of the first rod segment 240a and the inner radial surface (generally defined by the second seal surface 244) of the second piston member 234.

The external actuator 206 in the example illustrated includes a ball screw 207 rotationally driven by an electric motor 208. A ball nut 209 couples the second outer end 241b of the second rod segment 240b to the ball screw 207

In operation, the first piston member 232 may be at a retracted position adjacent the second end 218 of the cylinder housing 212 (FIG. 4), and the second piston member 234 may be at home position spaced axially intermediate the first piston member 232 and the first end 216 of the cylinder housing 212. The first and second seal surfaces 242 and 244 are spaced apart from each other, corresponding to a disengaged position.

The dual-mode actuator 210 may be operated in the positioning stroke mode by translating (axially advancing) the first piston member 232 towards the second piston member 234 by energizing the external actuator 206 in a first, advancing direction. Energizing the external actuator can cause relatively high speed, low force translation (shown at dotted line arrow 275 in FIG. 4) of the first piston member 232 and rod segments 240a, 240b attached thereto. During translation of the first piston member 232 towards the second piston member 234, fluid in the cylinder housing 212 on the front face side (first chamber 222a side) of the first piston member 232 can flow across the first piston member 232 through the first fluid passageway 256 to the back face side (second chamber 222b side) of the first piston member 232.

The fluid from the front face (or first chamber side) that flows across the first piston member 232 (the bypass fluid) need not be evacuated from the cylinder housing 212, for example via the first fluid port 224. This can reduce resistance to advancement of the first piston member 232 (for example, resistance associated with pushing a relatively large volume of fluid on the first chamber side 222a through a relatively small orifice such as fluid port 224), and can also reduce the amount of fluid required from a pressurized fluid source to back fill the second chamber 222b side of the first piston member 132.

In the example illustrated, insertion of the piston rod into the cylinder housing causes a decrease in the volume of the space 122 within the cylinder housing, so that some fluid (“evacuation fluid”) will generally be evacuated through either one of the ports 124, 126. However, the volume of the evacuation fluid is less than would be the case if no fluid could bypass the first piston member 132 as described above. In some examples, the first piston member can be configured with a double rod-end piston, so that a second piston rod extends from the first piston member and out through the first end 116 of the cylinder housing. The second rod end may be sized to have the same or similar diameter as the first rod end, so that the change in interior volume of the space 122 inside the cylinder housing as a result of translation of the first piston member can be reduced or eliminated.

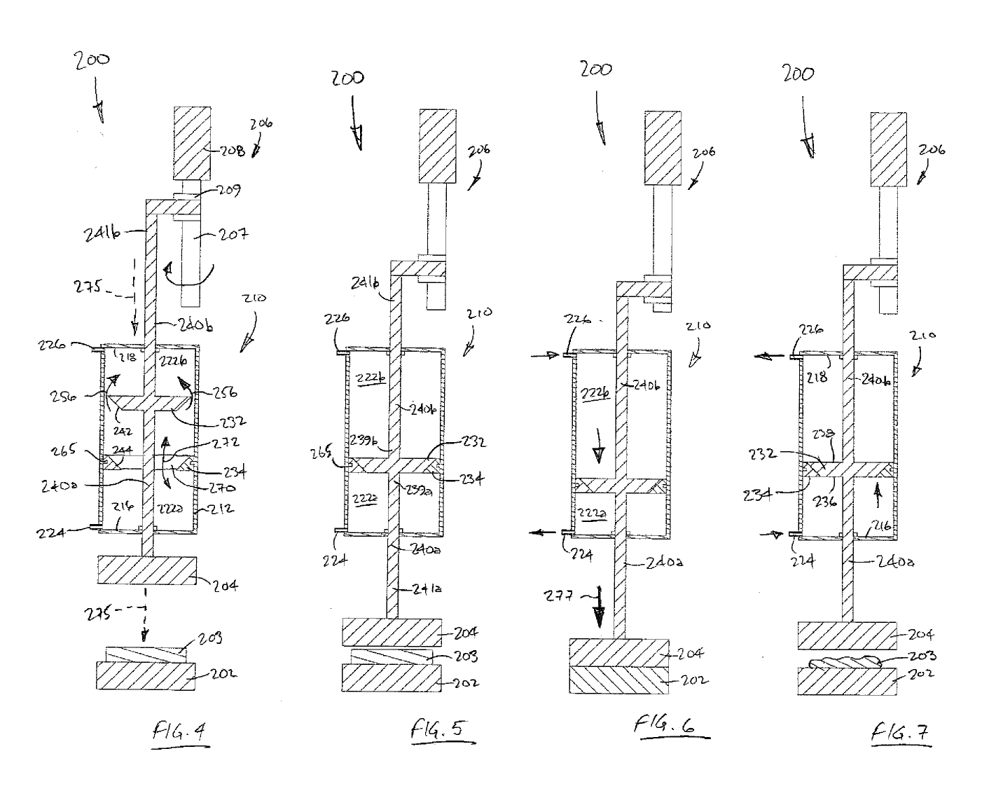

Referring to FIG. 5, the first piston member 232 is, in the example illustrated, translated axially by the external actuator 206 to bring the first seal surface 242 into engagement with the second seal surface 244. The first and second fluid chambers 222a, 222b are isolated from each other and fluid flow across the piston assembly 230 is inhibited.

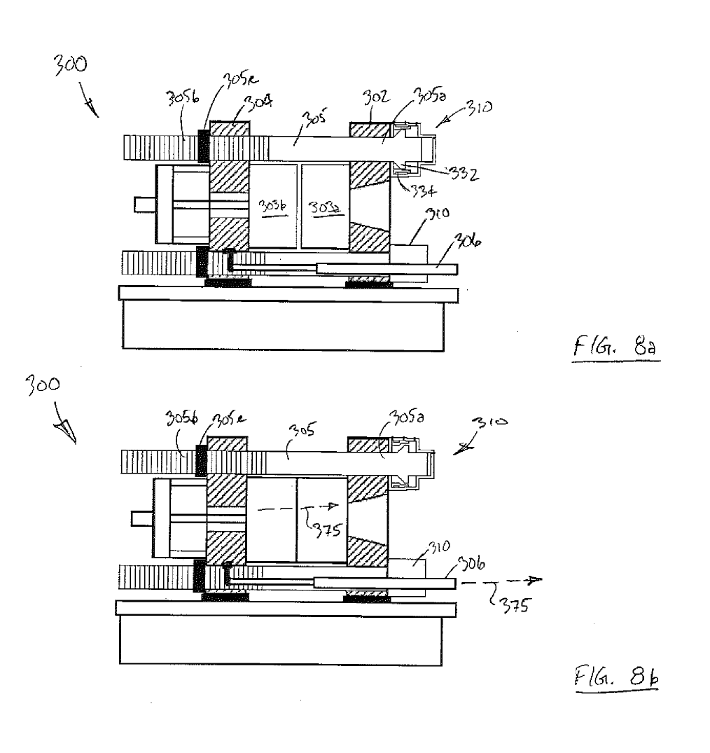

Referring to FIG. 6, the dual-mode actuator 210 may be operated in the working stroke mode by pressurizing the second chamber 222b with fluid via the second fluid port 126. The pressure in the second chamber 222b urges the sealed first and second piston members 232, 234 towards the first end 216, which transmits (via the first rod segment 240a of the first force transmission member) a corresponding pressing or clamping force (shown at solid line arrow 277 in FIG. 6) on a load (i.e. the moving die plate 204) coupled to the piston rod segment 240a. Fluid in the first chamber 222a can be evacuated via the first fluid port 224 in response to the advancing piston members 232, 234.

Referring to FIG. 7, to return to the “start” position of FIG. 4, the first fluid chamber can, in the example illustrated, be pressurized via first fluid port 224 to urge the first and second piston members 232, 234, while still engaged with each other, away from the first end 216 of the cylinder housing. This can be a relatively short stroke, sufficient to translate the second piston member 234 back to its home position. During this stroke, a resistive force can be exerted on the first piston member 232 to help maintain the first piston member in sealed engagement with the second piston member. The resistive force can be provided by energizing (or partially energizing) the external actuator 206 in the first (advancing) direction. This resistive force can counteract the force of the fluid in the first chamber 222a acting on the front face 236 of the first piston member 232, which may otherwise urge the first piston member 232 to disengage the second piston member 234.

Once the second piston member 234 has been translated back to its home position, the external actuator 206 can be energized in a second (retraction) direction to rapidly translate the first piston member 232 back to the retracted position. During this stroke, fluid in the second chamber 222b side of the cylinder housing 212 can flow through the first passageway 256 to the axially opposite, first chamber 222a side of the cylinder housing.

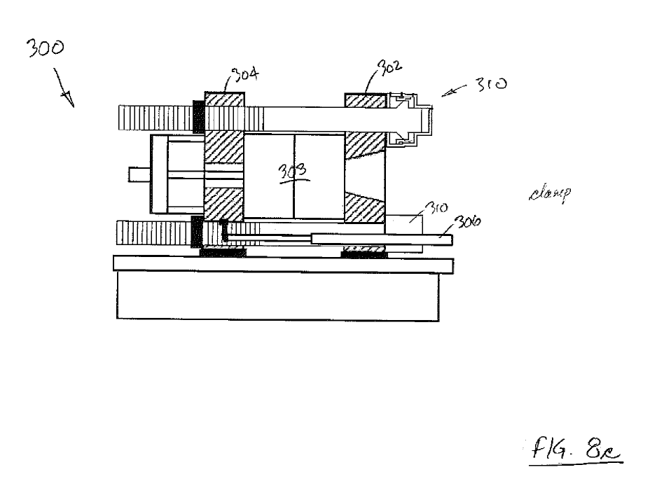

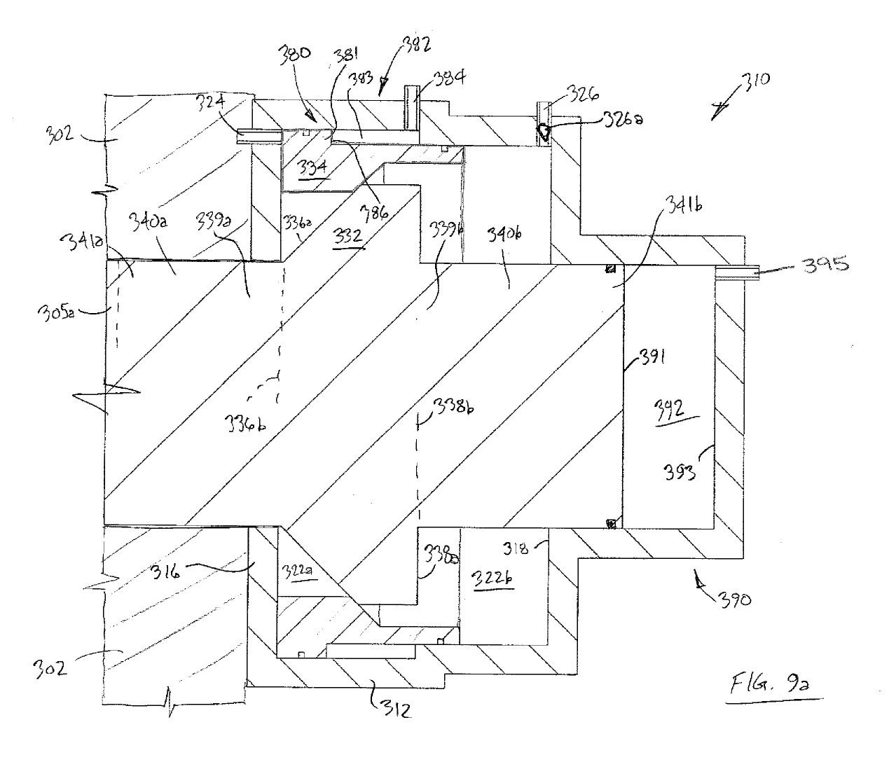

Referring now to FIG. 8a, an injection molding machine 300 incorporating another example of a dual-mode fluid powered actuator 310 is schematically illustrated.

The injection molding machine 300 includes a stationary platen 302 and a moving platen 304, each supporting a respective mold half 303a, 303b. The platens 302, 304 can be forcefully clamped together so that the mold halves 303a, 303b provide a mold 303 in which liquefied material can be injected to from a molded article.

To facilitate clamping together the platens 302, 304, the injection molding machine 300 is provided with a plurality of tie bars 305 extending axially between the platens 302, 304. In the example illustrated, each tie bar 305 has a first tie bar end 305a adjacent the stationary platen 302, and a second tie bar end 305b releasably lockable to the moving platen 304, for example, at a locking device 305c.

The injection molding machine 300 is further provided with a first external actuator 306 coupled to the moving platen 304. The first external actuator 306 may be used for rapidly translating the moving platen 304 between a mold open position (in which the moving platen is spaced relatively far away from the stationary platen) and a “shutter” position, in which the moving platen is in relatively close proximity to the stationary platen 302 (as shown, for example, in FIG. 8a). This translating step is generally performed with the tie bars 305 unlocked from the moving platen 304.

When in the shutter position, the locking mechanisms 305c may be moved to the locked position (by, for example, rotating a bayonet member) to engage the tie bars 305 and fix the axial position of the tie bars 305 relative to the moving platen 304. When so locked, the tie bars 305 are coupled to the external actuator 306 via the moving platen 304.

The injection molding machine 300 may be further provided with one or more dual-mode fluid powered actuators 310 that may facilitate closing the mold completely, and/or applying a clamp force across the platens during an injection cycle. In the example illustrated, one actuator 310 is associated with each tie bar 305. The fluid powered actuator 310 is similar to the fluid powered actuator 110 described previously, and similar features are identified by like reference characters, incremented by 200.

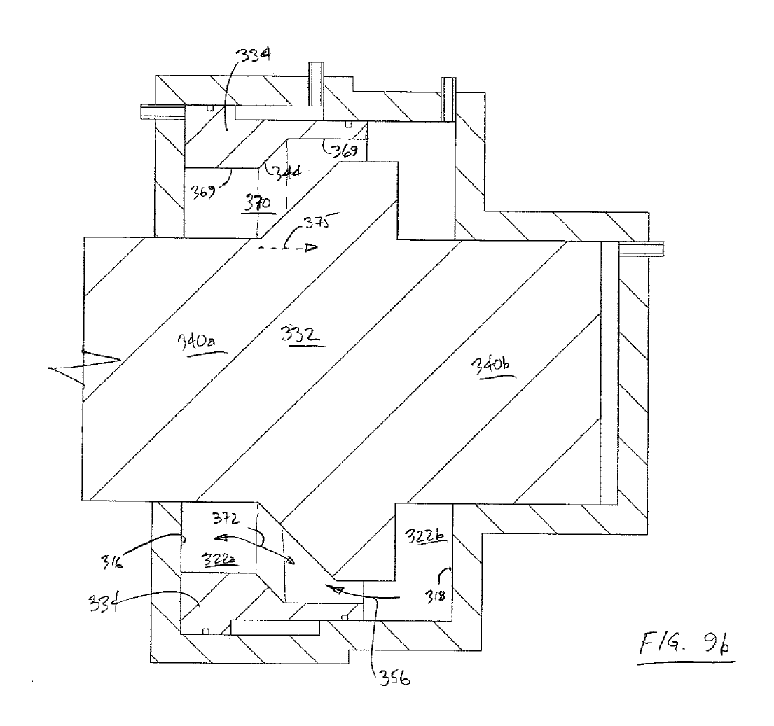

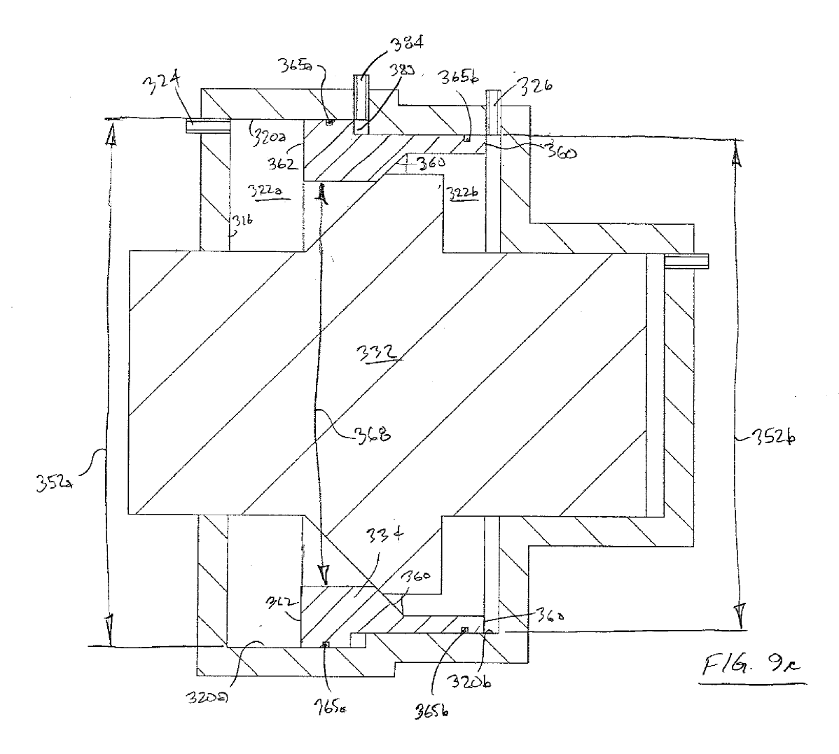

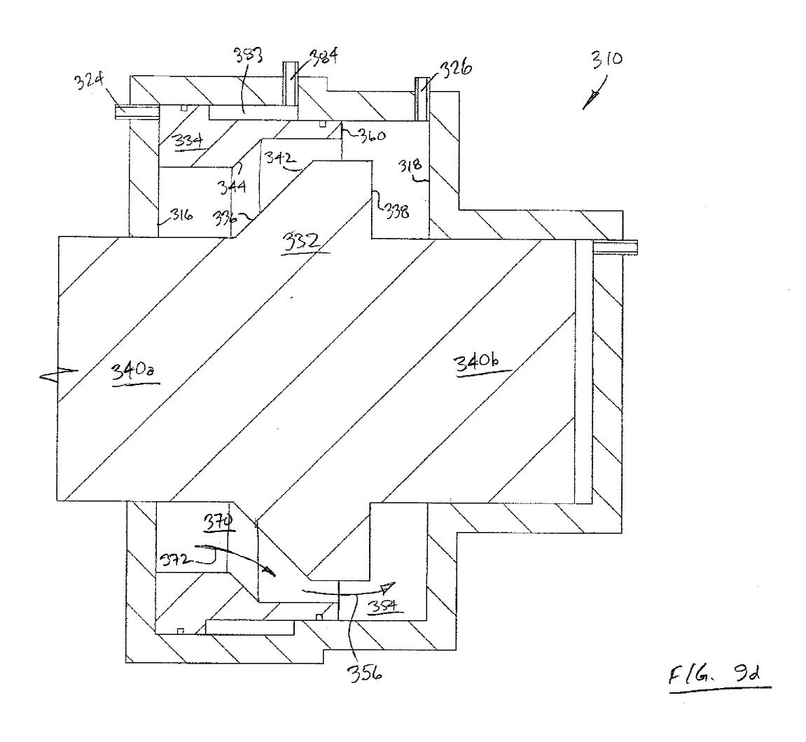

With reference also to FIG. 9a, the first force transmission member 340 of the actuator 310 comprises a double-ended piston rod, having a first rod segment 340a with a first inner end 339a connected to the front face 336 of the first piston member 332, and a second rod segment 340b with a second inner end 339b connected to the back face 338 of the first piston member 332.

The first rod segment 340a may be fixed to the first tie bar end 305a. In the example illustrated, the first rod segment 340a has a first outer end 341a protruding through the first end 316 of the cylinder housing 312 and fixed to the first tie bar end 305a of the tie bar 305. With the locking mechanism in the locked position, the first outer end 341a of the first rod segment 340a is coupled to the moving platen 304 to move axially therewith.

Referring to FIG. 9b, in the example illustrated, the first rod segment 340a passes through the central bore 370 of the second piston member 334. The second fluid passageway 372 across the second piston member 334, in the example illustrated, passes through an annular gap provided between the outer surface of the first rod segment 340a and the inner radial surface 369 (a portion of which comprises the second seal surface 344) of the second piston member 334.

In the example illustrated, the second rod segment 340b has a second outer end 341b protruding through the second end 318 of the cylinder housing 312. The first and second rod segments 340a, 340b of the double-ended piston rod have, in the example illustrated, generally equal diameters. The second outer end 341b may be connected to an optional third external actuator (discussed in greater detail subsequently herein).

The cylinder housing 312 of the actuator 310 has a stepped inner surface 320. The inner surface includes a first portion 320a having a first inner diameter 352a (FIG. 9c), and a second portion 320b having a second inner diameter of 352b. The first inner diameter 352a is, in the example illustrated, greater than the second inner diameter 352b. The second piston member 334 axially straddles the step in diameter, and has a first piston seal 365a in sealed sliding engagement with the inner surface first portion 320a, and a second piston seal 365b spaced axially apart from the first piston seal and in sealed sliding engagement with the inner surface second portion 320b.

The stepped inner surface facilitates providing the second piston member with front and back faces 360, 362 that have different effective surface area. In the example illustrated, the effective area of the front face 360 is defined by a projection of the front face 360 (including all surfaces having at least a portion directed towards the second end 318 of the housing) on a plane normal to the cylinder axis 314. In the example illustrated, the projected area of the front face 360 presents an annulus having an outer diameter equal to the second portion diameter 352b, and an inner diameter equal to the inner diameter 368 of the inner radial surface of the second piston member 334 (see FIG. 9c). The projected area of the back face 362 of the second piston member presents an annulus with the same inner diameter as for the front face 360, but having a larger outer diameter, the outer diameter being equal to the first portion inner diameter 352a.

In the example illustrated, the actuator 310 includes a second force transmission member 380 fixed to the second piston member 334 and engageable by a second external actuator 382, the second external actuator 382 isolated from the first and second fluid chambers 322a, 322b. In the example illustrated, the second external actuator 382 comprises a third fluid chamber 383 that can be pressurized with fluid via a third fluid port 384. The second force transmission member 380 comprises an arm 381 fixed to, and extending radially outwardly from the body of the second piston member 334 and having a pressure surface 386 exposed to the third fluid chamber 383. In the example illustrated, the third fluid chamber 383 is bounded at least partially by a portion of the inner surface of the 320 of the cylinder housing (and more particularly, by a portion of the inner surface second portion 320a), and the pressure surface 386.

Referring again to FIG. 9a, in the example illustrated, the second outer end 341b of the second rod segment 340b of the first force transmission member is connected to an optional third external actuator 390. The third external actuator comprises a fourth fluid chamber 392 disposed axially between an endface 391 of the outer end 341b of the second rod segment 340b, and a fourth chamber end wall 393 fixed relative to the cylinder housing 312. A fourth fluid port 395 is provided in the end wall 393 for fluid communication into and out of the fluid chamber 392. In he example illustrated, the fourth fluid chamber serves as an unclamp chamber for forcefully urging the mold towards the unclamp position. The second fluid chamber, in the example illustrated, serves as a low-pressure fluid reservoir for receiving fluid from the first chamber 322a side of the piston assembly when the first and second piston members 332, 334 move separately (in spaced-apart relation) towards the first end 316 of the housing 312, and for delivering fluid to the first chamber 322a side of the piston assembly 330 when the first and second piston members 332, 334 move separately away from the first end 316.

In the example illustrated, the second fluid port is fitted with a relief valve 326a that can be set at a relatively low pressure, for example, about 8-12 bar. If fluid in the second fluid chamber 322b reaches a level of pressurization greater than the set point of the relief valve, fluid is vented from the second chamber 322b through the relief valve 326a.

In use, the injection molding machine may, at the beginning of a cycle, ensure that the first piston member 332 (and hence the tie bar 305 attached thereto) is in a known or pre-established “shutter” position in which the position of the first piston member 332 is mechanically referenced relative to the cylinder housing 312. In the example illustrated, the second piston member 334 can be moved to a fully advanced position (to the left in FIG. 9a) by energizing the third pressure chamber 383 and venting the first fluid port 324 to tank. The first piston member 332 can be fully retracted (to the left in FIG. 9a) to abut the second piston member (first and second piston members 332, 334 in the engaged position).

With the first piston member 332 in the known shutter position, the axial position of the tie bar may be precisely known relative to a machine coordinate system. This can facilitate moving the locking device 305c to the locked position to lock the moving platen 304 to a respective one of the tie bars 305. For example, the tie bar 305 may have tie bar teeth spaced apart axially by first circumferential valleys, and the lock nut can have lock nut teeth spaced apart axially by second circumferential valleys.

With the first piston member in the shutter position, the moving platen 304 can be axially moved relative to the machine coordinate system to a “lock-up” position in which the lock nut teeth are axially aligned with, and can be rotated into the first circumferential valleys between the tie bar teeth. In the example illustrated, the first external actuator 306 is energized in an advance direction to rapidly translate the moving platen 304 to the lock-up position. In the example illustrated, an axial gap in the range of about 8 mm to about 20 mm is provided between the mold halves 303a, 303b when the moving platen is in the lock-up position. In some examples, the axial gap at the lock-up position may be less than 5 mm, and in some cases may be near 0 mm.

With the first piston member 332 in the shutter position and the moving platen 304 in the lock-up position, the locking devices 305c may be energized to lock the tie bars 305 to the moving platen 304.

After lock-up, the moving platen is further advanced to close the mold gap (FIG. 8b). In the example illustrated, this translation is accomplished by energizing the first external actuator 306. During this motion, the first and second fluid ports 324, 326 can be vented to tank. The fourth fluid port can also be vented to tank during this motion. In the example illustrated, this translation to close the mold gap causes a relatively high speed, low force movement of the moving platen 304 and the first piston member 334 as indicated by the dashed arrow 375 in FIGS. 8b and 9b.

With reference again to FIG. 9b, after closing the mold gap the first piston member has been advanced within the cylinder housing to an intermediate position, between the fully advanced and fully retracted positions. This intermediate position defines a datum position. Moving the first piston member to the datum position can facilitate providing adequate travel in the retraction direction, particularly in cases where a significant mold break force is required to open the mold after an injection cycle, and/or in cases where mold flash has occurred during injection.

Furthermore, in the example illustrated, moving the first piston member forward, away from the second piston member opens the first and second fluid passageways 356, 372 respectively. Immediately upon disengaging the second piston member 334, fluid on the second fluid chamber 322b side of the first piston member 332 can flow through first fluid passageway (in the direction of arrow 356 in FIG. 9b), towards the first fluid chamber 322a side of the first piston member 332.

Following the mold close/first piston member 332 advancement, the second piston member can be retracted away from the first end 316 of the housing 312, and back into engagement with the first piston member 332. In the example illustrated, the first fluid port 324 is supplied with pressurized fluid, which pressurizes both the first chamber 322a and second chamber 322b sides of the piston assembly. During this step the first fluid port 324 is fed with fluid at a relatively low pressure, below the pressure setting of the relief valve fixed in the second fluid port 326. Because the back face 362 of the second piston member 334 has a greater effective surface area than the front face 360, equal pressure on both faces results in a net force pushing the second piston member 334 away from the first end 316 of the housing 312, towards the first piston member 332.

During translation of the second piston member 334 towards the first piston member 332, fluid on the second chamber 332b side of the second piston member 334 can flow through the second fluid passageway 372 towards the first chamber 332a side of the second pressure member 334. The third fluid port 384 is, in the example illustrated, vented to tank during this step of translating the second piston member to re-engage the first piston member 332.

Upon engagement of the second piston member with the first piston member, the flow passages through the piston members 332, 334 are closed. Full clamping pressure may be applied by feeding high pressure fluid into the first fluid chamber 322a via fluid port 324. The fourth fluid chamber 392 is, in the example illustrated, vented to tank during clamp-up. The engaged first and second piston members 332, 334 are urged further to the right (as shown in FIG. 9c), to the fully clamped position of the piston assembly 330. This translation of the first and second piston members may displace some oil out of the second chamber 322b via the relief valve in the fluid port 326. As well, fluid may be displaced out of the fourth fluid chamber 392 via the fourth fluid port 395, and out of the second fluid chamber via the second fluid port.

After clamp-up, the first fluid port 324 can be opened to tank, venting pressure from the first fluid chamber 322a. The third fluid port 384 and fourth fluid port can be supplied with pressurized fluid, pressurizing the third and fourth fluid chambers 383, 392. The pressurized third fluid chamber urges the second piston member 334 to its advanced position (fully left in FIG. 9d), away from the first piston member 332. The fourth fluid chamber 392, when pressurized, exerts an unclamp force (mold break force) on the first piston member 332 via the second piston rod segment 340b. During leftward movement of the second and first piston members, fluid can flow across the piston members via the first and second fluid passageways 356, 372. At the completion of the unclamp stroke, the first and second piston members 332, 334 of the actuator 310 are positioned as shown in FIG. 9a.

While the above description provides examples of one or more processes or apparatuses, it will be appreciated that other processes or apparatuses may be within the scope of the accompanying claims.

1. A fluid powered actuator, comprising:
a) a cylinder housing having a cylinder axis, a first end and a second end spaced axially apart from the first end, and an inner surface extending between the first and second ends;
b) a first fluid port adjacent the first end of the cylinder housing and a second fluid port adjacent the second end of the cylinder housing;
c) a piston assembly in the cylinder housing, the piston assembly slidable between the first and second ports; and
d) the piston assembly including a first piston member and a second piston member, the first and second piston members translatable relative to each other between an engaged position in which the piston assembly isolates the first fluid port from the second fluid port, and a disengaged position in which the first and second fluid ports are in fluid communication with each other through the piston assembly.

2. The actuator of claim 1, wherein at least one of the first and second piston members has an outer piston seal in sealed sliding engagement with the inner surface of the cylinder housing.

3. The actuator of claim 1, further comprising a first fluid chamber adjacent the first end of the cylinder housing and a second fluid chamber adjacent the second end of the housing, the first and second fluid chambers in sealed isolation from each other by the first and second piston members when in the engaged position.

4. The actuator of claim 1, wherein the first piston member has a first seal surface and the second piston member has a second seal surface, and wherein the first and second seal surfaces abut when the first and second piston members are in the engaged position, and wherein the first and second seal surfaces are spaced apart when the first and second piston members are in the disengaged position.

5. The actuator of claim 4, wherein the first seal surface is affixed to the first piston member and is generally immovable relative to the first piston member during use of the actuator, and the second seal surface is affixed to the second piston member and is generally immovable relative to the second piston member during use of the actuator.

6. The actuator of claim 4, wherein the first seal surface is directed at least partially towards the first end.

7. The actuator of claim 6, wherein the second seal surface is directed at least partially towards the second end.

8. The actuator of claim 6, wherein when the first and second piston members are in the disengaged position, at least a portion of the second seal surface is disposed axially between at least a portion of the first seal surface and the first end.

9. The actuator of claim 4, wherein when the first and second piston members are in the engaged position, axial translation of the first member towards the first end causes a corresponding axial translation of the second member towards the first end of the cylinder housing.

10. The actuator of claim 4, wherein when the first and second piston members are in the engaged position, axial translation of the second piston member towards the second end causes a corresponding axial translation of the first piston member towards the second end of the cylinder housing.

11. The actuator of claim 3, wherein when the first piston member is spaced apart from the second end, the first piston member is translatable away from the first end without translating the second piston member.

12. The actuator of claim 11, wherein at least one of the fluid ports is in fluid communication with a pressurized fluid source for selectively pressurizing one of the first and second fluid chambers when the first and second piston members are in the engaged position.

13. The actuator of claim 12, wherein the first piston member has a first pressure surface exposed to the one of the first and second fluid chambers, and the second piston member has a second pressure surface exposed to the one of the first and second fluid chambers.

14. The actuator of claim 3, further comprising at least a first force transmission member coupled to the first piston member and engageable by a first external actuator.

15. The actuator of claim 14, wherein the first force transmission member comprises a piston rod having an inner rod end fixed to the first piston member and an outer rod end extending outward from at least one of the first and second ends of the cylinder housing.

16. The actuator of claim 15, further comprising a second force transmission member coupled to the second piston member and engageable by a second external actuator.

17. The actuator of claim 16, wherein the second force transmission member comprises a third pressure surface fixed to the second piston member, the third pressure surface exposed to a third fluid chamber that when pressurized exerts a force on the third pressure surface urging axial translation of the second piston member, wherein the third fluid chamber is in fluid isolation from the first and second fluid chambers.

18. The actuator of claim 17, wherein the second force transmission member comprises a second piston rod having a second rod inner end fixed to the second piston member and a second rod outer end extending outward from at least one of the first and second ends of the cylinder housing.

19. A fluid powered actuator, comprising:
a) a cylinder housing having a cylinder axis, a first end and a second end spaced axially apart from the first end, and an inner surface extending between the first and second ends;
b) a first fluid port adjacent the first end of the cylinder housing and a second fluid port adjacent the second end of the cylinder housing; and
c) a piston assembly in the cylinder housing, the piston assembly slidable between the first and second ports;
d) the piston assembly including a first piston member and a second piston member, the first piston member comprising a first seal surface and the second piston member comprising a second seal surface;
e) the first and second piston members translatable relative to each other to selectively engage the first seal surface with the second seal surface and to disengage the first seal surface from the second seal surface;
f) wherein when the first and second seal surfaces are engaged, a fluid chamber is provided in the cylinder housing on one axial side of the engaged first and second piston members for containing pressurized fluid to urge the engaged first and second piston members in one axial direction;
g) wherein when the first and second seal surfaces are disengaged, fluid in the cylinder housing flows across at least one of the piston members along the respective seal surface thereof in response to axial translation of at least one of the piston members.

20. A method of exerting a force on a load, comprising:
a) moving a first seal surface of a first piston member into engagement with a second seal surface of a second piston member by translating at least one of the first and second piston members relatively towards the other of the first and second piston members within a cylinder housing, at least one of the first and second piston members connectable to a load, wherein first and second fluid chambers are isolated from each other on axially opposite sides of the first and second piston members when the first and second seal surfaces are engaged;
b) pressurizing one of the first and second fluid chambers with pressurized fluid, wherein a force is exerted on the load; and
c) opening a first fluid passageway across the first piston member and a second fluid passageway across the second piston member by axially separating the first and second piston members to disengage the first and second seal surfaces;
d) translating at least one of the first and second piston members relative to the cylinder housing and away from the other of the first and second piston members, wherein fluid in the cylinder housing flows relative to the respective piston member across the respective piston member during translation thereof, via the respective first and second fluid passageway of the respective at least one first and second piston member.
